(19) United States
(12) Patent Application Publication
(10) Pub. No.: US 2014/0365398 A1
(43) Pub. Date: Dec. 11, 2014

(54) SYSTEM AND METHODS FOR MEDIA CONSUMPTION AND RATINGS THROUGH MOBILE DEVICES

(71) Applicant: Max DALTON, Leesburg, VA (US)

(72) Inventor: Max DALTON, Leesburg, VA (US)

(21) Appl. No.: 14/201,268

(22) Filed: Mar. 7, 2014

Related U.S. Application Data
(63) Continuation of application No. 13/094,570, filed on Apr. 26, 2011, now abandoned.
(60) Provisional application No. 61/328,281, filed on Apr. 27, 2010.

(51) Int. Cl. G06Q 30/02

(52) U.S. Cl. CPC G06Q 30/0282; G06Q 50/01
USPC 705/347

(57) ABSTRACT

An interactive published website (social network) designed for the general television viewing/media consuming public to have access and an opportunity to interactively submit their viewing opinion/habits on what television/media show they are or have just finished watching. Utilizing Designated Local Segment (DLS), a method of television ratings by market and other demographics, individuals can log into a website and register as members using a demographic application. Once a membership is established, members can mark the correct icons referenced to the television/media show they are or have just finished watching, pressing the send button will send us their input plus demographics of that member. The individual polling is electronically sent to a database where it is broken down and mathematically analyzed to provide a more accurate sampling of media ratings/consumption. The system is designed to correlate, aggregate, and display television ratings, media consumption habits, and consumer buying habits based on data collected from various sources. The application uses the aggregated data to identify and track developing trends. Market segment types include location, race, age, gender, or any other demographic that can be recorded.

This application claims the benefit of U.S. provisional application Ser. No. 61/328,281, filed Apr. 27, 2010.

### BACKGROUND OF THE INVENTION

1. Field of the Invention

The present invention relates to the field of television ratings. More particularly, the present invention relates to the method and techniques for quickly, efficiently and more accurately retrieving and analyzing data input from members of iTVbuzz.com. iTVbuzz is a membership social network where members can list and rate media consumed in exchange for points/prizes/cash, etc.

2. Description of Related Art

Currently, only one company is providing widespread statistical polling media ratings services, but through set-top boxes. However, they are not and have not provided any specifications regarding interactive television ratings. In contrast, this invention provides the ability to all television viewers to log into our website and tell us what television show they are or have just finished watching.

The primary problem with our competitor's service is that they only collect data from a selected number of households through set-top boxes and systematically extrapolate a mathematical analysis of the U.S. public average. By taking our polling service directly to the public, we feel that we can make this specification more of an accurate and realistic real time assessment of media consumption for our clients and the public.

### SUMMARY OF INVENTION

The invention is an interactive social media network, polling, and streamed content delivery website designed for all television viewers to have an opportunity to interactively submit their input on what television show/network they are or have just finished watching. This website will serve as a Television Ratings service and live streaming of selected television broadcast for the public, television networks, television network affiliates, television stations, the media, advertising agencies, advertisers, sponsors of shows, production companies and other media outlets and affiliates. Any iTVbuzz.com member will have an opportunity to log into our website and have an opportunity to share their input on what television show they have or are watching at a specific date and time (in real time) and whether they liked or disliked the show by a ratings system of 1-5 (whereas 1 is poor and 5 is best). By pressing the “send” button, their data input will be sent to our database warehouse where our database will break down the information from that member, resulting in a scientific survey measurement. This information will be broken-down as time stamp, media source and media device (where available), member name, email address, gender, age or age group, ethnicity, market (based on zip code), how many other viewers watched the show with that member and enjoyment level.

The website is open for membership to the general television viewing public. As members of iTVbuzz.com individuals or families can log into our website and input what Television show or station they are watching at a specific time of the day from whatever device they have in hand, i.e., a tablet, smart-phone, laptop, interactive cable, desk PC. Individuals or families become members of iTVbuzz.com by going into our website and filling out a form that will establish them as our member. This form will ask general questions such as:

Name: (Used for identification purposes)

Address: (Used for verification of U.S. residency)

Gender: (Used for Gender identification and statistics)

Date of Birth: (Used for age grouping purposes)

Ethnicity: (Used to average the population as whole or within a market)

Email Address: (Used for login and individual membership purposes)

Time Zone: (Used to establish what market the member is located)

When these individuals input their information, our database will issue them a membership ID (this could be their email address) and a password for future log-in process into our website. Member's information is confidential and it is used for our internal verification purposes only. At which point, the individual member or a family as a whole will become part of the iTVbuzz.com family member.

An iTVbuzz.com family member will have access to our website and be able to log in with us at any given time to give us their input. They can tell us what Television show (or network) they are watching, or have just finished watching by clicking on certain icons and pressing the send button. We intend to share this information (give, trade or sell this information) with television networks, network affiliates, other television stations, the media, advertising agencies, advertisers, sponsors of shows, production companies and other media outlets and affiliates. The objective of this system is to create a new method for television ratings.

### BRIEF DESCRIPTION OF THE DRAWINGS

FIG. 1 shows a schematic of the information paths according the invention for members and clients of the website.

FIG. 2 shows an initial information taking screen from the system.

FIG. 3 shows a sample media review screen.

FIG. 4 shows a flow chart of system operation and member access.

FIG. 5 shows a schematic of system dataflow and interaction through the web.

FIG. 6 shows a flow of information to and from members and buyers of system produced media consumption information.

FIG. 7 shows a media consumption/ratings results data output from the website.

FIG. 8 shows a Ratings Detail from the website

FIG. 9 shows a points accumulation system for members.

FIG. 10 shows a table of media markets in the US and their corresponding population.

### DETAILED DESCRIPTION

We have created a website that will allow any individual within the television viewing service area of North America to log-in and give somewhat detailed information about themselves and their television viewing habits. Our website will retrieve volunteered information from the television viewers who are members of our site. Our database will systematically analyze this information and conduct a mathematical analysis of this polling service. This statistical overview will be averaged out in many different forms to give us an average of these results combined with our Designated Local Segment (DLS).

We may take these results and submit them publicly and/or to private industries. Our main objectives are to:
Create a new method for television ratings.
Allow television viewers to give their input on their television viewing/media consumption (radio, internet radio, YouTube, internet TV) habits or their input or thoughts on what they are watching and whether they liked or disliked the show.
To collect information from TV viewers about the source from which the media they consume is broadcast or delivered, and the device(s) on which they consume media.
To create a more accurate television ratings service for the public, television networks, television network affiliates, television stations, the media, advertising agencies, advertisers, sponsors of shows, production companies and other media outlets and affiliates.
To create a direct connection between media buyers and sellers in a non-biased, regulated medium that will create an open market for airtime availability
To generate a broad base of income from the services provided.

When these individuals input their information, our database will issue them a membership ID (this could be their email address) and a password for future log-in procedure into our website. Member's information is confidential and it is used for our internal verification purposes only. Their input, not their personal information will be shared with clients. At which point, the individual member or a family as a whole member will become part of the iTVbuzz.com family member portal. An iTVbuzz.com family member will have access to our website and be able to log in with us at any given time to give us their input. They can tell us what Television show or network or media they are watching or have just finished watching by clicking on certain icons and pressing the send button. We intend to share this information (give, trade or sell this information) with television networks, television network affiliates, television stations, the media, advertising agencies, advertisers, sponsors of shows, production companies and other affiliates. The objective of this system is to create a new method for television/all media ratings.

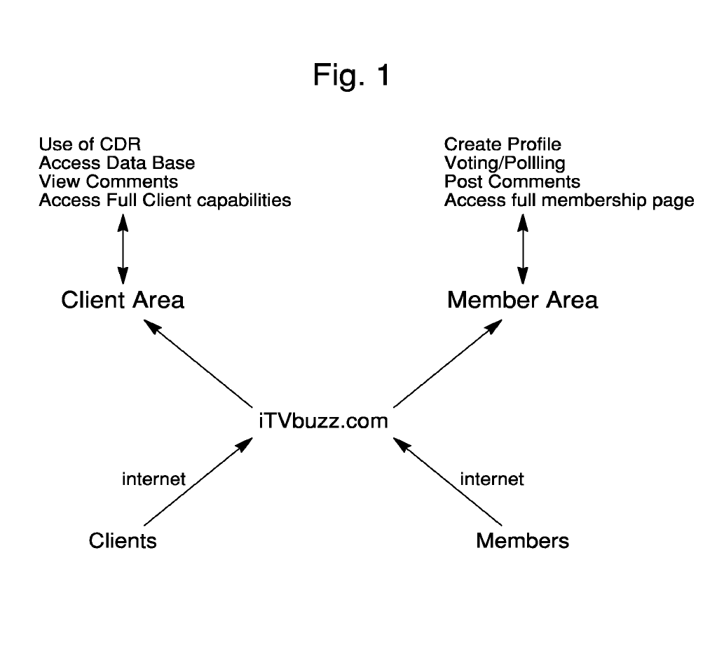

As shown in FIG. 1, TVbuzz collects information from viewers who are simultaneously watching broadcast/cable or streaming television using a handheld device, PC, or laptop computer to access the internet. It is also designed to expand to record viewing habits of media content syndicated by the iTVbuzz web services. Additionally, the system allows for internet-enabled televisions to record viewing habits of broadcast television, contingent on the cooperation of the broadcast provider (IE cable or satellite providers).

In addition to collecting TV & online media viewing habits, iTVbuzz is designed to collect demographic information such as name, age, race, gender, interests, and etc. This information can be posted to social networking sites through whatever available means, and displayed on both iTVbuzz and 3rd party social network websites. Also, users can communicate with each other through iTVbuzz. Because of this, the viewing habits information that is collected can be connected to demographics information on a personal, non-arbitrary basis.

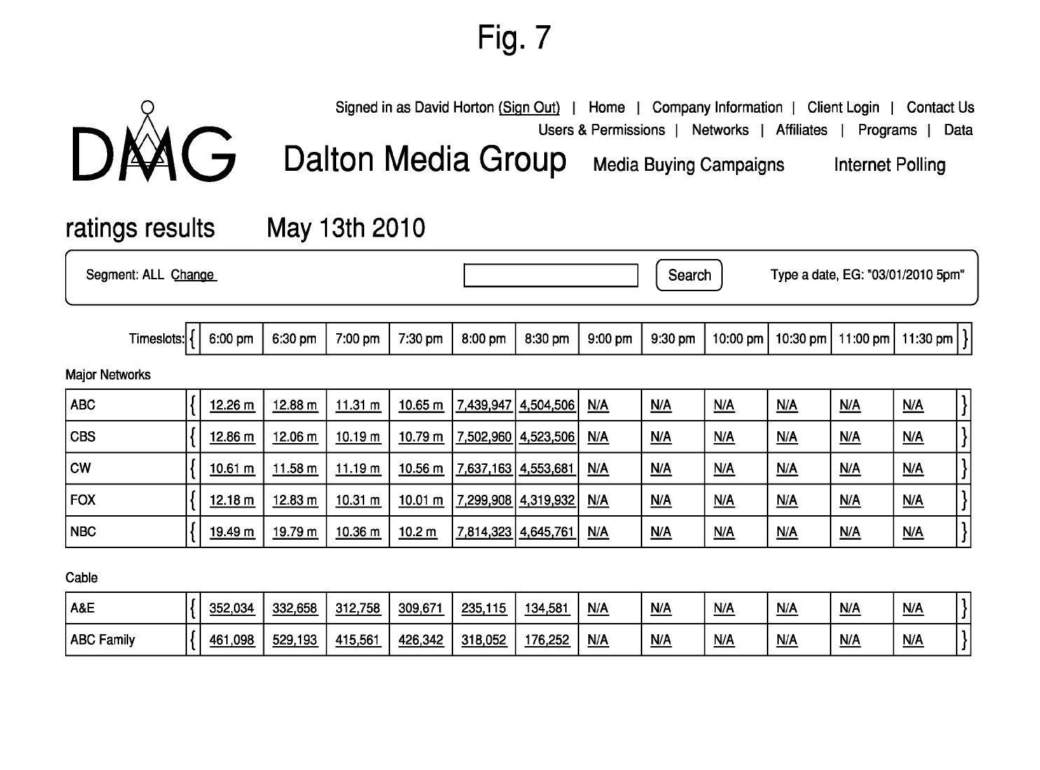

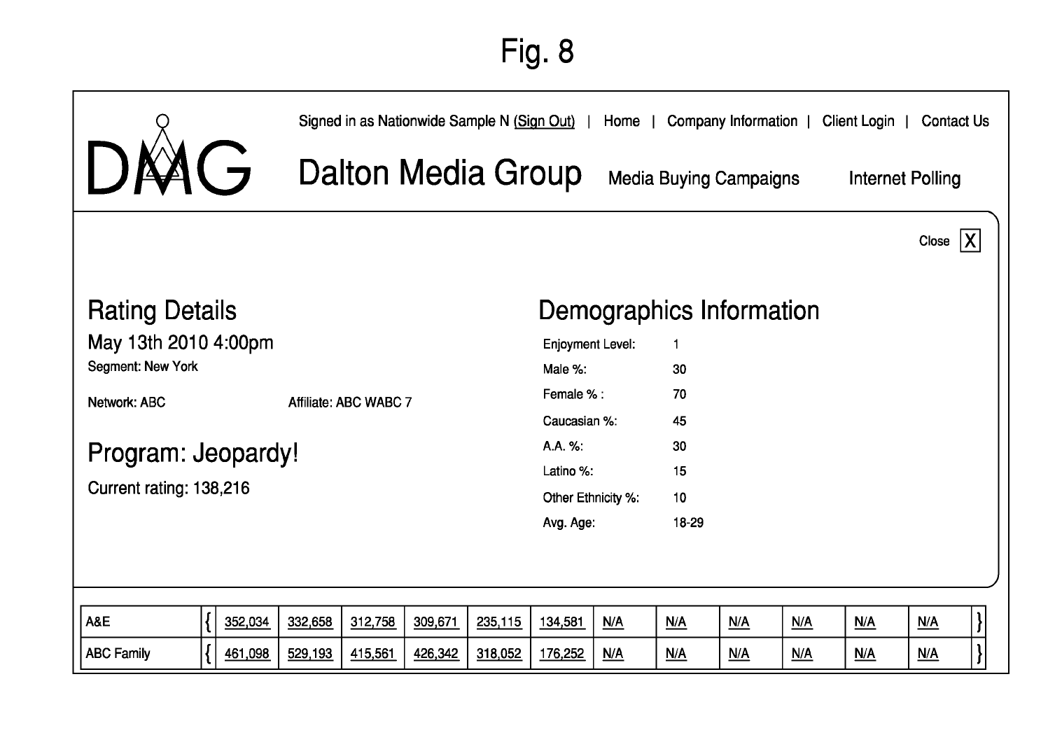

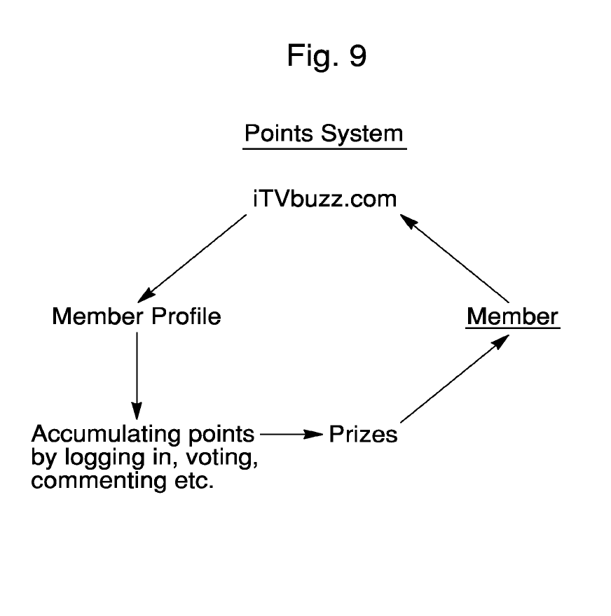

FIG. 1 shows the respective paths of connection and information flow from members into iTVbuzz and to the other members and clients of the site. Members enter demographic information and rate shows to accumulate points and win prizes. Also, however, members can have a social web experience around the shows, leave comments for stars, fan mail, etc. Clients have access to that member information, comments, profiles, etc. but also purchase data from the site in either bulk form for their own analysis or purchase site created reporting, as shown in FIGS. 7 and 8.

The system herein includes live and pre-recorded streaming content provided by us through third party or television/cable content providers. Within the site, members are able to login and view any content that we give access to. Once logged in, they have the ability to search and find a streaming content of their choice to view and vote for in real time. By using a TV set, computer or a mobile device they will have access to the content that we will have available for them. Within that viewing page, we are able to locate their market or their current position in that specific market.

iTVbuzz.com member interaction with celebrities. A live streaming broadcast of TV celebrities Question and Answer segment can be hosted between site members and a celebrity. iTVbuzz.com will host a live streaming of a celebrity or public figure on the website sponsored by a client (advertiser or other media entity). Three commercials will be played during the thirty minute broadcast. A moderator will randomly choose the questions that members are posting online. The celebrity will answer those questions one at a time. Member may receive a prize from iTVbuzz.com if the question is chosen by the moderator and answered by celebrity. iTVbuzz.com members will have access to live streaming between friends. Utilizing a third party or our own streaming channel, a member can chat live and stream their broadcast privately or publicly with other members.

iTVbuzz is designed to provide feedback regarding TV shows and event associated media (i.e., concert or ball game streamed content) in “real time”, which allows analysts to coordinate comments with specific points or parts of a broadcast. For example, a specific 60 second commercial clip or preview may elicit comments and ratings unto itself. It is a common perception that a significant portion of Superbowl viewers are actually as interested in the commercials as are interested in the game itself Advertisers have tried to capitalize on that audience interest in the past; iTVbuzz takes that further with rapid real time rating from a variety of platforms. Advertisers could know, almost instantly, what platforms (smartphone, TV, laptop, theatre screen, etc.) succeeded and which did not for a given advertisement.

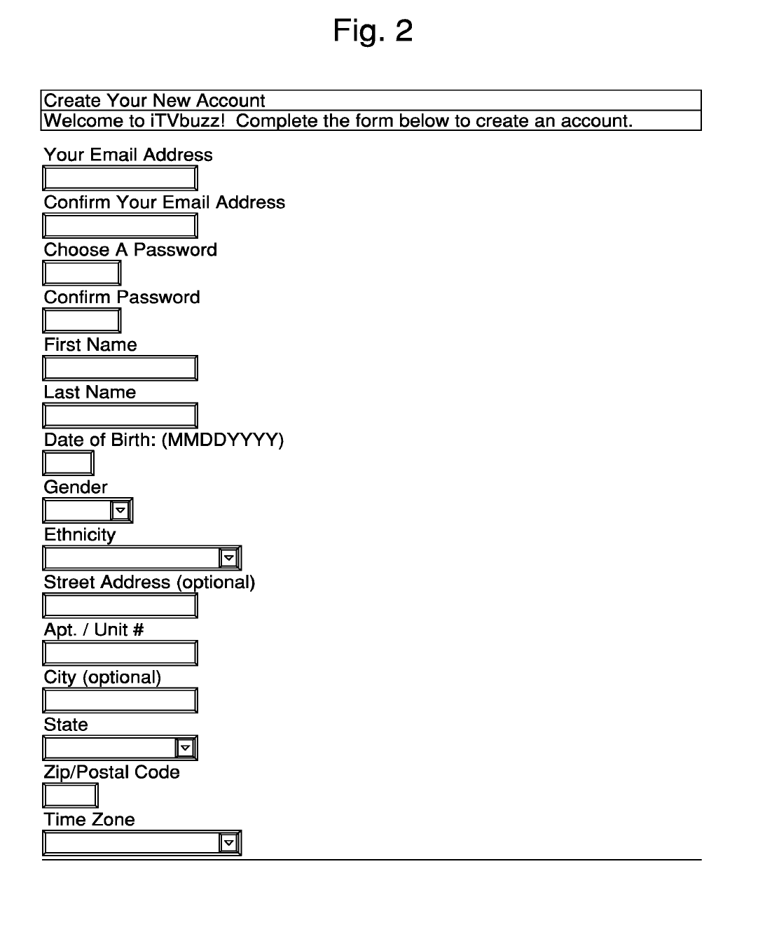

iTVbuzz collected data passes through its own reporting application in order to be aggregated and displayed alongside other data sources available to Dalton Media Group or iTVbuzz. In operation, see FIG. 2, the first web page view is structured as an introduction page where an individual can log into and give us certain information about themselves. In this membership registration form we require certain information such as: gender, date of birth, address or at least the zip-code, email address and ethnicity. By pushing the “send” or “create an account” button, this information is transferred to our data base portal from the individual and will help us acknowledge and confirm their existence and identify them as who they are. We require this personal information from the individual to establish a more accurate and scientific mathematical statistic in our research regarding this television ratings/polling service.

This information is then broken down in whole and in several different categories such as: gender, date of birth, address, market, email address and ethnicity. This information is crucial to us as it will tell us who this person is and which television market he/she is in. we require this information for our statistical analysis retrieval system. When this information is given to us, the individual will receive an email that will tell him/her they are now members of iTVbuzz.com and must activate the membership through instructions sent to them via email. The membership activation is an additional key press that will communicate that response with our database portal for validation purposes.

The “type the two words” box in our account setup will be customized with our client product placement opportunity, whereas we will charge an ad fee to the client to utilize that box for product placement of their product. For example: we could charge Ford motor company a fee to have new members type in a Ford product as displayed instead of a random word or number for “human” verification stat. We may resell this offing to other membership based websites.

We will give this member a temporary password to login. They will need this user name password to log in with us and give us their input on what show they are or have just finished watching. We structure a specific web page that the member will be automatically directed to. This web page is a page designed for the member's geographical television marketing area. Every time a member logs into our site he/she will be directed to that market or geographic page assigned for that market or time-zone.

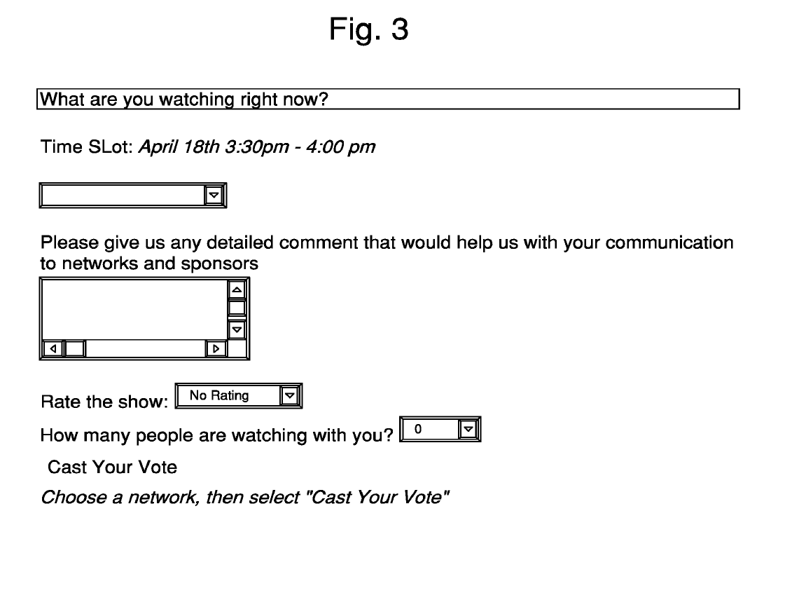

The new member from time to time will be able to log in at anytime and give us information regarding what television show they have watched. They do this by using their login name and password. At this point they will see a page that will clearly identify that specific user and the user will be given choices on what they have watched as seen in FIG. 3. The member's choices and encrypted database displays on the screen will be as follows: the date, time of viewing or log in, the name of the television network, station or cable.

The icons in front of choices can be pressed using a computer mouse. The choices will also include a button for “none” if they did not watch television at that moment. Once the choice has been selected they will be required to press the send button and the volunteered input will be sent to our database where it will be broken down for our internal use.

An “enjoyment level” button is also available on display for the show. They may also make a comment regarding the show or network that they are watching. The database will break down the information that member has just sent to us via our website.

A member can receive points every time they log-in. when a member logs in they get a point, when they vote or make a comment they can receive additional points. These points can be accumulated and exchanged for prizes that we may offer. These points can be redeemed for prizes such as laptops and mobile devices. Our system automatically registers a member to receive points. The system would know when the member logs in and when they vote to gain additional points when they comment on those shows.

Mobile device application for television ratings would consist of registering or logging into iTVbuzz.com for the purpose of voting for a show or network, watch streaming television, voting for that stream or video, communicating with other iTVbuzz.com members, making comments to others or responding to other comments. Also, to vote for shows that a user is watching on another device such as a computer or television set.

The application would be downloaded by user onto a mobile device such as a mobile phone or a device that does not require wired connection to the internet. The user would register his/her information voluntarily to the iTVbuzz.com website in which case then would be transferred to the database using the mobile device application. After a registered user has activated that account via email he/she would have the opportunity to login and begin using their new iTVbuzz.com functions.

Full Functions on the mobile device would be equivalent to the functions on iTVbuzz.com. The capability to vote for a show, chat with friends or other members, watch live streaming or other content provided by iTVbuzz.com or a third party, etc.

Members can create trending topics for others to view. Members can upload videos into their profile page. iTVbuzz.com may from time to time create or give members the opportunity to create a topic or a polling segment for others to participate in. within membership pages we can give access of web applications to create their own polling results on certain tops.

We conduct this television ratings/polling service at a national level, and then expand into international markets. We will use this site to add additional links for marketing purposes. We will give the member an opportunity to preview a specific television show before it is shown on television. We will create chat rooms so members will be able to meet one another and be able to chat about anything. We will designate chat rooms for specific shows where the producers and television network executives can go into and look at what people are saying about their shows. These chats maybe displayed on the comments page in real-time.

Members are able to utilize our reminder page. This page provides a member with a reminder email to text on when their favorite show will air. The member will simply select a program or network from our reminder page and ask our system to send a reminder up to one day prior to remind the member that their show is going to air so they can watch it on-time. With a smart phone application download into a mobile device, members can create and account or/and login and give us data on what they are watching. With a real time GPS locator we are able to see where they are and where they are voting from.

Features of smart-phone application:
Use iTVbuzz.com to vote and participate in television ratings
Everything is calculated in real time, so vote as often as you want.
Create a profile or remain as an anonymous user.
Invite or chat with friends.
Earn points to qualify for incentive items such as a smart-phone (iphone, Droid, ipads), laptop or special offers from networks.
Connect with friends in other networks like Facebook/twitter.
Login from anywhere using your mobile device.
Create a fan club for your favorite show.
Upload photos and videos to your profile.

All of these features will also be incorporated into our mobile device applications as well.

We will utilize the information from the database storage to mathematically analyze a statistical average on television viewing samples retrieved from the public. A limited amount of this information will be released to the public and a more detailed information will be released to clients. A detailed information release will consist of information regarding the gender, age, market and ethnicity of the average television viewers, extrapolated using our formula of demographic statistics per capita.

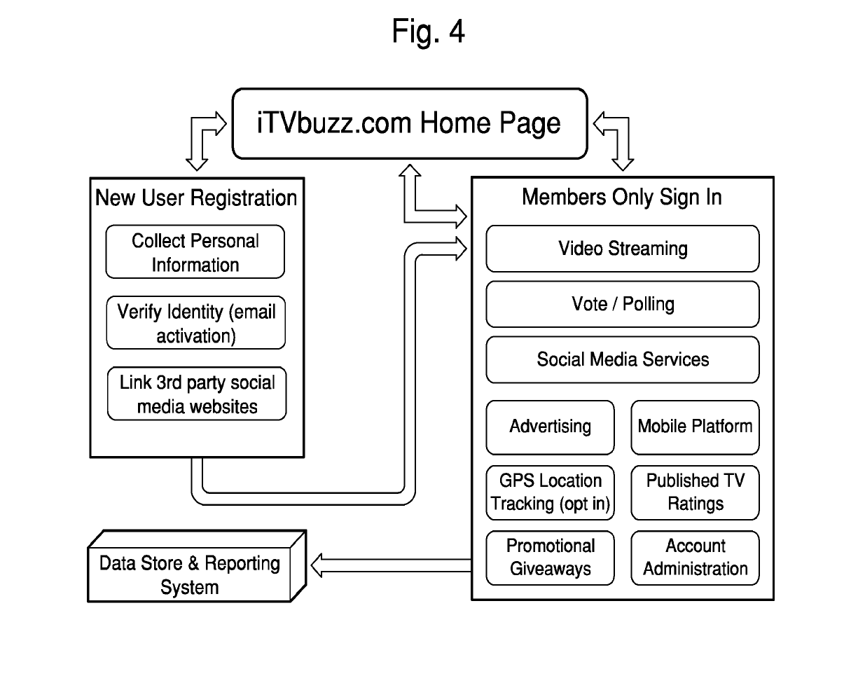

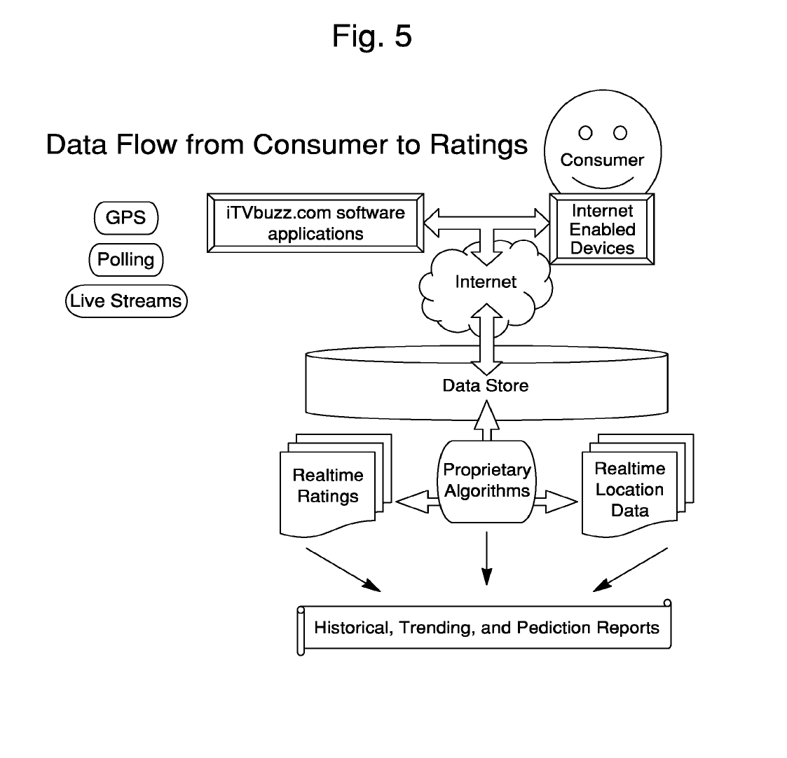

Viewers can also vote, as shown in FIGS. 4 and 5, and interact with other TV viewers and have full access to iTVbuzz.com features by using set top box widgets. iTVbuzz.com widgets can be incorporated into set top boxes provided by third party applications or software. A TV remote control can be used to access the iTVbuzz.com features such as voting, polling, chatting, sending messages and viewing listings.

Clients can consist of television networks, television stations, cable companies, ad agencies, television sponsors etc. these clients will have special privileges to special website that will only they have access to. They will be able to view averages and possibly full polling totals of the voting from our members. Clients can see gender, age, market and ethnicity of the members. However, we will hold the identity of our members from them and the general public.

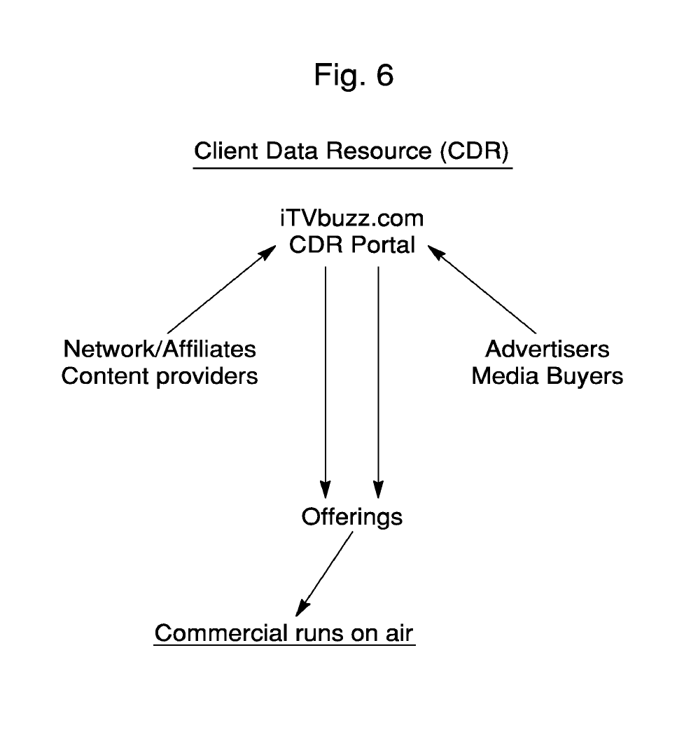

Clients can buy and sell airtime (television broadcast time) online using our Client Data Resource or CDR as shown in FIG. 6. Our CDR is structured for media buyers and advertisers to connect with content providers in reference to purchasing airtime. Content providers can utilizes our calendar structure webpage platform to offer available airtime schedules. Advertisers or representatives can secure those open airtime schedules for their advertising needs or preferences.

The same can be done in reverse, whereas, an advertiser can create or establish a budget and market requirement or preference for their advertising and be able to make those offerings to the content provider. The content provider meeting those requirements will take that order using the CDR platform and guarantee the advertiser airtime for those set date and time.

DMG will create a platform to allow advertisers and TV stations or network to solicit their services/products in real time. TV stations or networks can offer available airtime to advertisers: if a station has unsold airtime and would like to offer that timeslot to an advertiser, they can do so through the DMG website. Same would be true in a reversed situation whereas, an advertiser can solicit their advertising budget dollars to an open public forum and a station can secure that budget for the purpose of running that ad in a timeslot. The available airtime schedule and securing that time slot will be guaranteed by content provider to the advertiser. Content provider would have the advertising on file or be able to download it from the advertiser or representative through our website.

Dalton Media Group Reporting is an application designed to correlate, aggregate, and display television ratings, media consumption habits, and consumer buying habits based on data collected from various sources. The application uses the aggregated data to identify and track developing trends.

DMG Reporting is designed to track trends by market segments. Market segment types include location (DLS or Designated Location Segment), race, age, gender, or any other demographic that can be recorded. Market segment types are further divided into individual segments by various methods. For example, in a hypothetical “Report A”, the ‘Age’ segment might include ages 10-15, 16-21, 22-25, and 26-34. For “Report B” it could include ages 15-30, 30-50, and 50+. This ability to “break out” segments using multiple methodologies on demand creates a very large repository of reports, which can be edited to reflect the needs of any particular user.

Once market segment types and market segments have been identified, DMG Reporting uses a ‘program-time-based’ system to identify trends. All information collected has a date stamp, and most of the information collected also has a time stamp. A program is defined as any consumable media available to our tracking system. Typically a program is a television show, movie, or online video.

When providing television ratings, popularity of a local event, or media available online, DMG Reporting uses all available data from the U.S. Census, internet polling, and other sources to calculate the total number of individual persons consuming the media and use this as a whole/part or as sampling guideline for total results. To do this, DMG Reporting uses the most up to date population estimates available from the United States Census for each 3 digit ZIP code, and takes into account the known trends in daily media consumption per capita.

The code interface for DMG Reporting and iTVbuzz is written in PHP, HTML, and JavaScript code. This system provides a method for collecting and retrieving data from whatever available sources, aggregating the data, and posting it into the various market segments grouped by segment type for analysis.

Data is analyzed in real time and inserted into the ‘rating segment’ table, but user ID numbers are not recorded. This keeps information that is aggregated confidential. Although the user ID is still used by the software code to retrieve all available information related to a specific user, once ratings or trends are calculated and posted into the DMG Reports ‘rating segment’, no individual can be identified.

DMG Reporting provides methods for pulling reports based on date, segment type, individual segments or specific segments within a segment type, and/or information correlated to a specific piece of segment data (EG: which media programs are most popular among ages 18-25?). See, for examples, FIGS. 7 and 8.

A set of code to accomplish the foregoing is set forth below at the end of this specification.

Designated Location Segments (DLS) is a breakdown of Television Markets within the borders of United States television viewing signal reception (analog or digital).

Our DLS is a creation that derives from a combination of different sources of census of local and federal government. We have taken the total population of the US and have modified the identification of the TV viewing public to be 85% of that population.

Designated Location Segments are geographical divisions of the US separated by zip code. Each DLS is comprised of zip codes from one or more states. Which zip codes are in each segment is derived from several factors: population density, broadcast availability (IE what channels are typically available from local cable providers and how far those channels reach out from their broadcast location), and proximity to major metropolitan areas or geographical landmarks (EG: New York City, Gulf Coastal Region).

The entire North American continent is contained in the Dalton Media Group DLS system, but the system allows for other types of DLS segments each containing different zip codes to be custom-created for our clients. Additionally, Designated Segments (DS) can be created within the same system that are not location but rather demographics-based (EG: 10 DS for each of the 10 age groups 1-10,10-20, etc. . . . ).

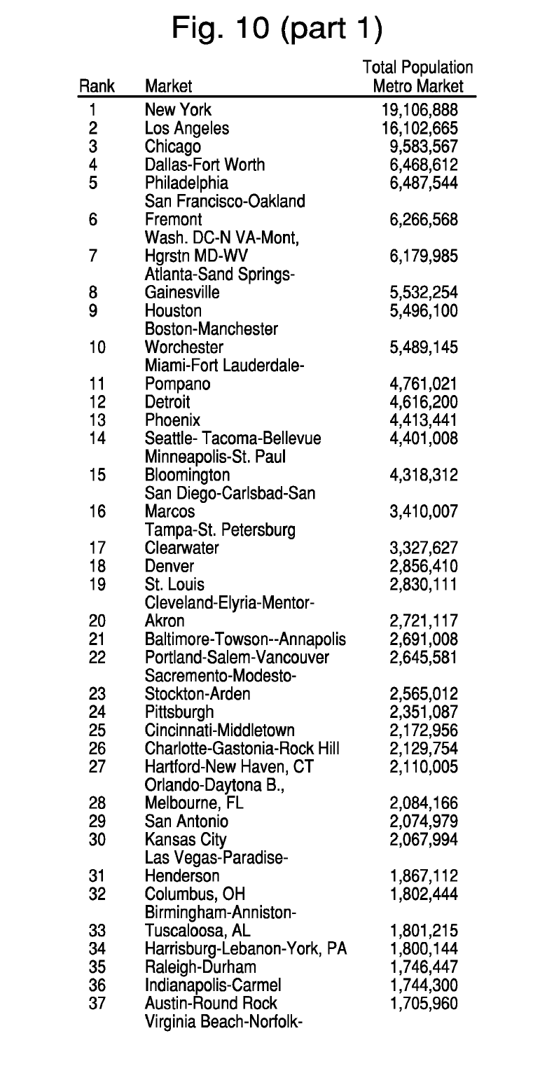

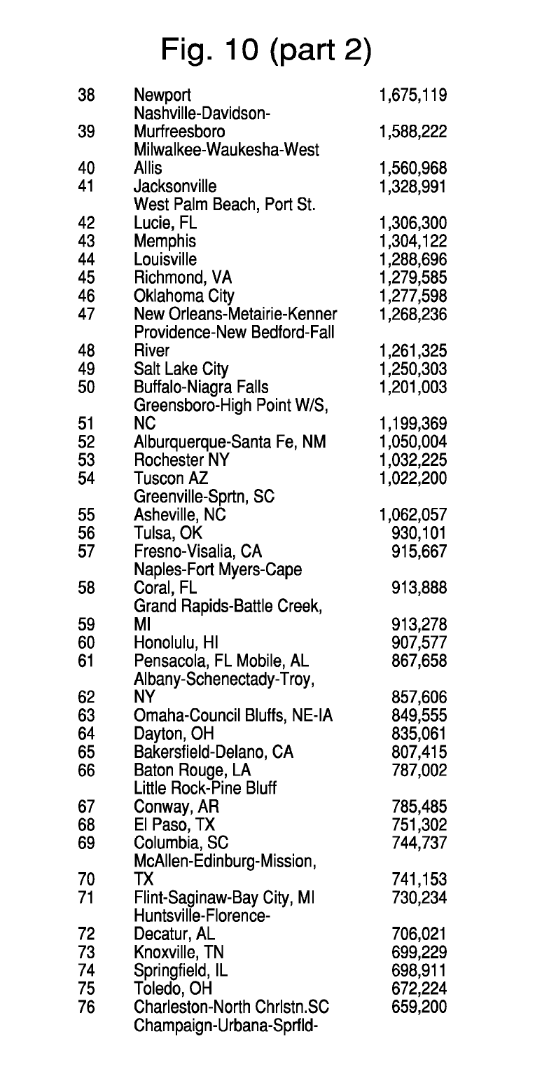

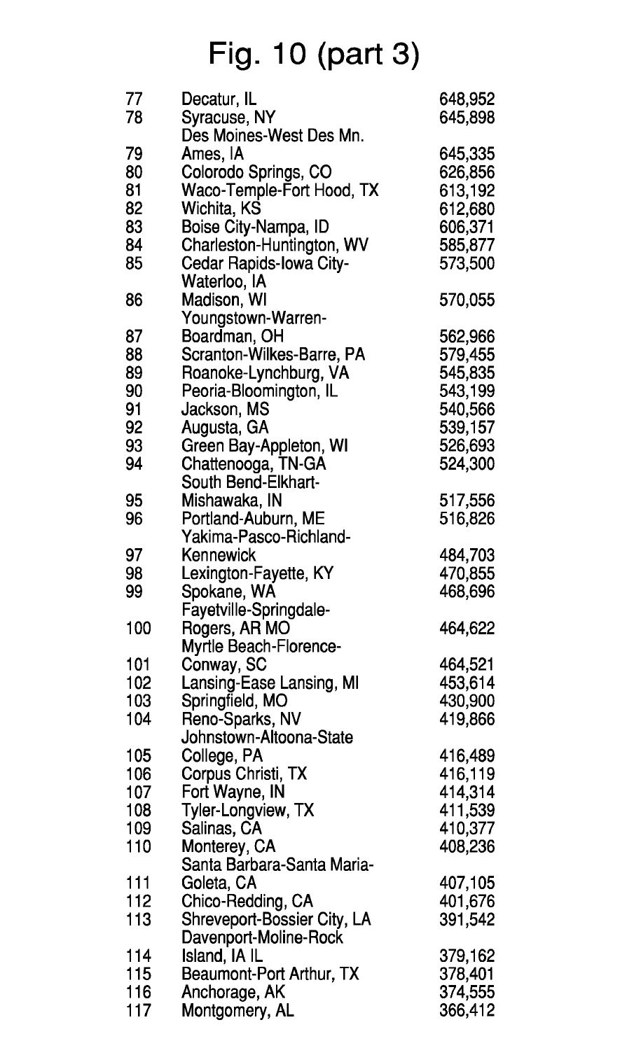

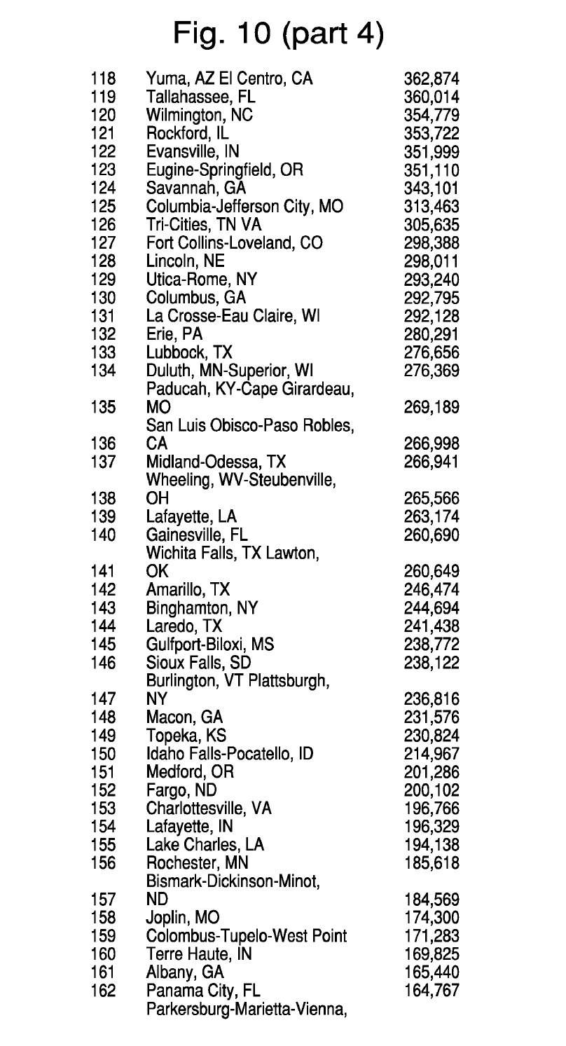

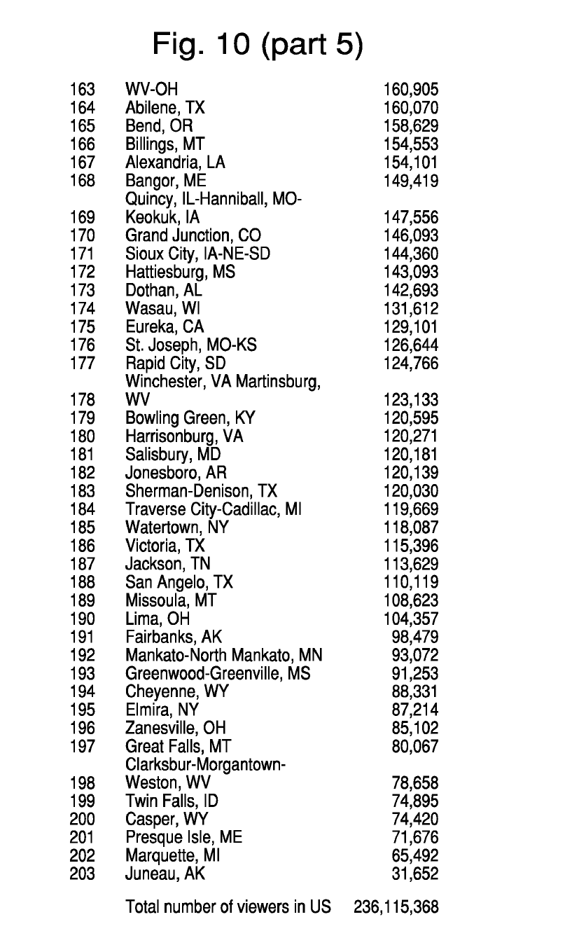

Broken down by age range, ethnicity, gender within designated markets or metropolitan areas. Our DLS data gives us our own version of the total market breakdown of how many people in the US watch television, where most of these people are located and their demographics as whole or in part. The first unedited (2.1) version of the DLS is in FIG. 10: which shows only the first 203 markets of the DLS. We may revise this every now and then as new numbers are released by the United States Census and other organizations.

While the invention has been described herein in a single embodiment, other versions will occur to those of ordinary skill in the field. The invention is only to be delimited by the appended claims.

Detailed Database Structure with Notes

| iTVbuzz | | iTVbuzz |
|---|---|---|
| CREATE TABLE IF NOT EXISTS ‘blacklist‘ ( | | Table structure for table ‘blacklist‘ |
| | ‘url‘ varchar(256) NOT NULL, | describes known malicious websites to prevent malicious content from |
| | ‘domain‘ varchar(256) NOT NULL | being posted on the website |
| | ) ENGINE=MyISAM DEFAULT CHARSET=latin1; | |
| CREATE TABLE IF NOT EXISTS ‘groups‘ ( | | Table structure for table ‘groups‘ |
| | ‘id‘ int(2) NOT NULL auto_increment, | each user is part of a group (IE Staff or Members) |
| | ‘parent‘ int(2) NOT NULL, | |
| | ‘name‘ varchar(30) NOT NULL, | |
| | ‘code‘ varchar(5) NOT NULL, | |
| | PRIMARY KEY (‘id‘) | |
| ) ENGINE=MyISAM DEFAULT CHARSET=latin1 | | |
| AUTO_INCREMENT=4 ; | | |
| CREATE TABLE IF NOT EXISTS ‘network‘ ( | | Table structure for table ‘network‘ |
| | ‘id‘ bigint(20) NOT NULL auto_increment, | Describes the television networks and cable channels |
| | ‘name‘ varchar(100) NOT NULL, | |
| | ‘type‘ varchar(20) NOT NULL, | |
| | PRIMARY KEY (‘id‘), | |
| | KEY ‘type‘ (‘type‘) | |
| ) ENGINE=MyISAM DEFAULT CHARSET=latin1 | | |
| AUTO_INCREMENT=52 ; | | |
| CREATE TABLE IF NOT EXISTS ‘ratings‘ ( | | Table structure for table ‘ratings‘ |
| | ‘id‘ bigint(20) NOT NULL auto_increment, | describes individual ratings for tv networks |
| | ‘epoch‘ bigint(20) NOT NULL, | |
| | ‘network_id‘ int(5) NOT NULL, | |
| | ‘user_id bigint(20) NOT NULL, | |
| | ‘ip_addr‘ varchar(60) NOT NULL, | |
| | ‘timezone‘ double NOT NULL, | |
| | ‘howmany‘ int(1) NOT NULL, | |
| | ‘comments‘ varchar(500) NOT NULL, | |
| | ‘rating‘ int(1) NOT NULL, | |
| | ‘epoch_real‘ bigint(20) NOT NULL, | |
| | PRIMARY KEY (‘id‘), | |
| | KEY ‘epoch‘ (‘epoch‘,‘network_id‘,‘user_id‘), | |
| | KEY ‘timezone‘ (‘timezone‘), | |
| | KEY ‘ip_addr‘ (‘ip_addr‘), | |
| | KEY ‘epoch_real‘ (‘epoch_real‘) | |
| ) ENGINE=MyISAM DEFAULT CHARSET=latin1 | | |
| AUTO_INCREMENT=35 ; | | |
| CREATE TABLE IF NOT EXISTS ‘roles‘ ( | | Table structure for table ‘roles‘ |
| | ‘id‘ int(2) NOT NULL auto_increment, | describes various website roles (IE ′Staff′ or ′Member′) |
| | ‘name‘ varchar(30) NOT NULL, | |
| | ‘code‘ varchar(5) NOT NULL, | |
| | PRIMARY KEY (‘id‘) | |
| ) ENGINE=MyISAM DEFAULT CHARSET=latin1 | | |
| AUTO_INCREMENT=11 ; | | |
| CREATE TABLE IF NOT EXISTS ‘users‘ ( | | Table structure for table ‘users‘ |
| | ‘id‘ int(5) NOT NULL auto_increment, | (IE consumers) |
| | ‘email‘ varchar(150) NOT NULL, | |
| | ‘pass‘ varchar(128) NOT NULL, | |
| | ‘fname‘ varchar(50) NOT NULL, | |
| | ‘lname‘ varchar(50) NOT NULL, | |
| | ‘ip‘ varchar(128) NOT NULL, | |
| | ‘session‘ varchar(128) NOT NULL, | |
| | ‘cookie‘ varchar(128) NOT NULL, | |
| | ‘last_logged‘ bigint(20) NOT NULL, | |
| | ‘status‘ int(1) NOT NULL, | |
| | ‘foreign_id‘ int(5) NOT NULL, | |
| | ‘address1‘ varchar(100) NOT NULL, | |
| | ‘address2‘ varchar(50) NOT NULL, | |
| | ‘city‘ varchar(50) NOT NULL, | |
| | ‘state‘ varchar(2) NOT NULL, | |
| | ‘zip‘ varchar(10) NOT NULL, | |
| | ‘ethnicity‘ varchar(30) NOT NULL, | |
| | ‘timezone‘ double NOT NULL, | |
| | ‘gender‘ varchar(1) NOT NULL, | |
| | ‘dob‘ varchar(8) NOT NULL, | |
| | ‘join_epoch‘ bigint(20) NOT NULL, | |
| | PRIMARY KEY (‘id‘), | |
| | KEY ‘email‘ (‘email‘), | |
| | KEY ‘cookie‘ (‘cookie‘) | |
| ) ENGINE=MyISAM DEFAULT CHARSET=latin1 | | |
| AUTO_INCREMENT= 10048 ; | | |
| CREATE TABLE IF NOT EXISTS ‘user_activity‘ ( | | Table structure for table ‘user_activity‘ |
| | ‘id‘ bigint(20) NOT NULL auto_increment, | tracks activities such as voting, blogging, friending, etc . . . |
| | ‘user_id‘ bigint(20) NOT NULL, | |
| | ‘epoch‘ bigint(20) NOT NULL, | |
| | ‘description‘ varchar(300) NOT NULL, | |
| | PRIMARY KEY (‘id‘), | |
| | KEY ‘user_id‘ (‘user_id‘,‘epoch‘), | |
| | FULLTEXT KEY ‘description‘ (‘description‘) | |
| ) ENGINE=MyISAM DEFAULT CHARSET=latin1 | | |
| AUTO_INCREMENT=138 ; | | |
| CREATE TABLE IF NOT EXISTS ‘user_blog‘ ( | | Table structure for table ‘user_blog‘ |
| | ‘id‘ bigint(20) NOT NULL auto_increment, | |
| | ‘user_id‘ bigint(20) NOT NULL, | |
| | ‘epoch‘ bigint(20) NOT NULL, | |
| | ‘title‘ varchar(100) NOT NULL, | |
| | ‘content‘ text NOT NULL, | |
| | PRIMARY KEY (‘id‘), | |
| | KEY ‘user_id‘ (‘user_id‘,‘epoch‘), | |
| | FULLTEXT KEY ‘content‘ (‘content‘), | |
| | FULLTEXT KEY ‘title‘ (‘title‘) | |
| ) ENGINE=MyISAM DEFAULT CHARSET=latin1 | | |
| AUTO_INCREMENT=11 ; | | |
| CREATE TABLE IF NOT EXISTS ‘user_friends‘ ( | | Table structure for table ‘user_friends‘ |
| | ‘user_id‘ bigint(20) NOT NULL, | |
| | ‘friend_id‘ bigint(20) NOT NULL, | |
| | ‘pending‘ int(1) NOT NULL, | |
| | ‘epoch‘ bigint(20) NOT NULL, | |
| | ‘rank‘ bigint(20) NOT NULL, | |
| | KEY ‘user_id‘ (‘user_id‘,‘friend_id‘,‘pending‘), | |
| | KEY ‘epoch‘ (‘epoch‘) | |
| ) ENGINE=MyISAM DEFAULT CHARSET=latin1; | | |
| CREATE TABLE IF NOT EXISTS ‘user_links‘ ( | | Table structure for table ‘user_links‘ |
| | ‘id‘ bigint(20) NOT NULL auto_increment, | users post their favorite links on their profiles |
| | ‘user_id‘ bigint(20) NOT NULL, | |
| | ‘url‘ varchar(256) NOT NULL, | |
| | ‘link_name‘ varchar(256) NOT NULL, | |
| | ‘epoch‘ bigint(20) NOT NULL, | |
| | PRIMARY KEY (‘id‘), | |
| | KEY ‘user_id‘ (‘user_id‘), | |
| | KEY ‘epoch‘ (‘epoch‘), | |
| | FULLTEXT KEY ‘link_name‘ (‘link_name‘) | |
| ) ENGINE=MyISAM DEFAULT CHARSET=latin1 | | |
| AUTO_INCREMENT=17 ; | | |
| CREATE TABLE IF NOT EXISTS ‘user_multi‘ ( | | Table structure for table ‘user_multi‘ |
| | ‘id‘ bigint(20) NOT NULL auto_increment, | users can post multimedia from various websites on their profiles |
| | ‘user_id‘ bigint(20) NOT NULL, | |
| | ‘url‘ text NOT NULL, | |
| | ‘multi_name‘ varchar(256) NOT NULL, | |
| | ‘epoch‘ bigint(20) NOT NULL, | |
| | PRIMARY KEY (‘id‘), | |
| | KEY ‘user_id‘ (‘user_id‘,‘epoch‘), | |
| | FULLTEXT KEY ‘multi_name‘ (‘multi_name‘) | |
| ) ENGINE=MyISAM DEFAULT CHARSET=latin1 | | |
| AUTO_INCREMENT=26 ; | | |
| CREATE TABLE IF NOT EXISTS ‘user_photos‘ ( | | Table structure for table ‘user_photos‘ |
| | ‘id‘ bigint(20) NOT NULL auto_increment, | |
| | ‘user_id‘ bigint(20) NOT NULL, | |
| | ‘caption‘ varchar(200) NOT NULL, | |
| | ‘epoch‘ bigint(20) NOT NULL, | |
| | ‘rank‘ smallint(6) NOT NULL, | |
| | PRIMARY KEY (‘id‘), | |
| | KEY ‘user_id‘ (‘user_id‘), | |
| | KEY ‘epoch‘ (‘epoch‘,‘rank‘), | |
| | FULLTEXT KEY ‘caption‘ (‘caption‘) | |
| ) ENGINE=MyISAM DEFAULT CHARSET=latin1 | | |
| AUTO_INCREMENT=75 ; | | |
| CREATE TABLE IF NOT EXISTS ‘user_profile‘ ( | | Table structure for table ‘user_profile‘ |
| | ‘id‘ bigint(20) NOT NULL auto_increment, | each user can activate a profile with personal information |
| | ‘user_id‘ bigint(20) NOT NULL, | |
| | ‘display_name‘ varchar(40) NOT NULL, | |
| | ‘headline‘ varchar(200) NOT NULL, | |
| | ‘approve_comments‘ int(1) NOT NULL, | |
| | ‘about_me‘ text NOT NULL, | |
| | ‘url‘ varchar(50) NOT NULL, | |
| | ‘num_views‘ bigint(20) NOT NULL, | |
| | ‘default_photo‘ mediumint(9) NOT NULL, | |
| | ‘flag_private‘ int(1) NOT NULL, | |
| | ‘flag_enabled‘ int(1) NOT NULL, | |
| | PRIMARY KEY (‘id‘), | |
| | UNIQUE KEY ‘url‘ (‘url‘), | |
| | UNIQUE KEY ‘user_id‘ (‘user_id‘), | |
| | KEY ‘flag_private‘ (‘flag_private‘,‘flag_enabled‘), | |
| | FULLTEXT KEY ‘about_me‘ (‘about_me‘) | |
| ) ENGINE=MyISAM DEFAULT CHARSET=latin1 | | |
| AUTO_INCREMENT=50 ; | | |
| CREATE TABLE IF NOT EXISTS ‘user_reports‘ ( | | Table structure for table ‘user_reports‘ |
| | ‘user_id‘ bigint(20) NOT NULL, | users can report activity that is against our privacy policy and terms of use. |
| | ‘reported_id‘ bigint(20) NOT NULL, | |
| | ‘comments‘ text NOT NULL, | |
| | KEY ‘user_id‘ (‘user_id‘), | |
| | KEY ‘blocked_id‘ (‘reported_id‘) | |
| ) ENGINE=MyISAM DEFAULT CHARSET=latin1; | | |
| CREATE TABLE IF NOT EXISTS ‘user_roles‘ ( | | Table structure for table ‘user_roles‘ |
| | ‘id‘ int(2) NOT NULL auto_increment, | relates each user to their group and role |
| | ‘user_id‘ int(5) NOT NULL, | |
| | ‘group_id‘ int(5) NOT NULL, | |
| | ‘role_id‘ int(5) NOT NULL, | |
| | PRIMARY KEY (‘id‘), | |
| | KEY ‘user_id‘ (‘user_id‘) | |
| ) ENGINE=MyISAM DEFAULT CHARSET=latin1 | | |
| AUTO_INCREMENT=57 ; | | |
| CREATE TABLE IF NOT EXISTS ‘user_shoutbox‘ ( | | Table structure for table ‘user_shoutbox‘ |
| | ‘id‘ bigint(20) NOT NULL auto_increment, | users can post comments into each other‘s profiles |
| | ‘user_id‘ bigint(20) NOT NULL, | |
| | ‘sender_id‘ bigint(20) NOT NULL, | |
| | ‘comments‘ varchar(1000) NOT NULL, | |
| | ‘pending‘ int(1) NOT NULL, | |
| | ‘epoch‘ bigint(20) NOT NULL, | |
| | PRIMARY KEY (‘id‘), | |
| | KEY ‘user_id‘ (‘user_id‘,‘sender_id‘,‘pending‘), | |
| | KEY ‘epoch‘ (‘epoch‘), | |
| | FULLTEXT KEY ‘comments‘ (‘comments‘) | |

) ENGINE=MyISAM DEFAULT CHARSET=latin1
AUTO_INCREMENT=10 ;

What I claim is:

1. A website and internet enabled method for a membership and media ratings/polling service, comprising the steps of:
a first member user accessing and logging into said website using a membership identifier previously provided by said website;
said first member rating a media packet, using media related icons as a menu guide, previously consumed by said member;
awarding points to said member according to a predetermined points accumulation system related to the media rated;
said first member optionally providing additional comments to accompany their prior rating;
aggregating and storing said first member user entered ratings and comment data in accord with a predetermined correlation relating to at least one of first member user media consumption device and zip code location;
said first member logging off from said website;
a second client member user logging into said website and accessing prior recorded first member user entered media ratings and optional comments;
downloading aggregated first member user ratings and comment data to a second computer for off-site analysis by said second client member user; and,
logging said second client member off said website.

2. A method as in claim 1, wherein:
said first member user is consuming media and accessing said website through a handheld mobile device.

3. An internet enabled system for providing media ratings data, comprising:
a server including a memory, a processor, a data entry interface and a screen, said server being web accessible through said internet;
a media consuming device having a screen, a memory, a processor, and a data entry interface, also being web accessible;
said media consuming device being enabled to access said server and provide ratings of media consumed on said media consuming device through said internet;
said server aggregating and storing said ratings data;
a third device also being web accessible and including a processor, a memory, a screen, and a data entry interface, said third device accessing stored aggregated ratings data and downloading said data to said third device for analysis.

4. A system as in claim 3, wherein:
said media consuming device is a handheld portable device.
